(19) United States
(12) Patent Application Publication
(10) Pub. No.: US 2018/0101375 A1
(43) Pub. Date: Apr. 12, 2018

(54) DATA STORAGE DEVICE INITIATION OF FIRMWARE DOWNLOAD DURING INACTIVITY

(71) Applicant: Lenovo Enterprise Solutions (Singapore) Pte. Ltd., Singapore (SG)

(72) Inventors: Patrick L. Caporale, Cary, NC (US); Theodore B. Vojnovich, Raleigh, NC (US)

(21) Appl. No.: 15/291,278

(22) Filed: Oct. 12, 2016

(51) Int. Cl. G06F 9/445; H04L 29/08

(52) U.S. Cl. CPC G06F 8/65; G06F 8/63; H04L 67/34

(57) ABSTRACT

A method includes a data storage device having a device parameter, said data storage device identifying a firmware image that is associated with said device parameter and is a more current version than a firmware image installed on the data storage device, wherein the identified firmware image is available from a firmware repository. The method further includes the data storage device initiating a download of the identified firmware image from the firmware repository during a period of time that the data storage device is handling no input-output tasks. Optionally, the method may further include the data storage device pausing the download of the firmware image from the firmware repository in response to receiving an input-output task.

### BACKGROUND

### Field of the Invention

The present invention relates to methods of updating firmware in a connected device.

### Background of the Related Art

In a typical data storage environment, disk drives contain a firmware image which may require routine updates to provide critical fixes, performance enhancements, or to add a new feature. A firmware package is typically created by a host device and the disk drive is updated when the host device, such as a server or storage subsystem to which the disk drive is connected, sends the firmware package to the disk drive. When the host sends the firmware package, it is necessary for the disk drive to suspend all input-output tasks.

The number and types of storage subsystems have increased at an accelerated rate in recent years as the volume of data that needs to be retained has rapidly expanded. Many modern disk drives contain some type of firmware that is executed on the disk drive itself and is subject to change over the lifetime of the disk drive. These disk drives include SATA, SAS, and NVMe drives. Updating the firmware may be complicated by the presence of multiple types or models of disk drives that require different firmware images. Accordingly, the host device may implement a complex application to coordinate the transfer of the appropriate firmware packages to the appropriate disk drives.

### BRIEF SUMMARY

One embodiment of the present invention provides a method comprising a data storage device having a device parameter, said data storage device identifying a firmware image that is associated with said device parameter and is a more current version than a firmware image installed on the data storage device, wherein the identified firmware image is available from a firmware repository. The method further comprises the data storage device initiating a download of the identified firmware image from the firmware repository during a period of time that the data storage device is handling no input-output tasks.

Another embodiment of the present invention provides a computer program product comprising a non-transitory computer readable storage medium having program instructions embodied therewith, wherein the program instructions are executable by a processor to cause the processor to perform a method. The method comprises a data storage device identifying a firmware image that is associated with a device parameter that matches a device parameter of the data storage device and is a more current version than a firmware image installed on the data storage device, wherein the identified firmware image is available for download from a firmware repository. The method further comprises the data storage device initiating a download of the identified firmware image from the firmware repository during a period of time that the data storage device is handling no input-output tasks.

### BRIEF DESCRIPTION OF THE SEVERAL VIEWS OF THE DRAWINGS

FIG. 1 is a diagram of a plurality of data storage devices coupled to a host device.

FIG. 2 is a diagram of a computer that may serve as a host device.

FIG. 3 is a flowchart of a method according to one embodiment of the present invention.

### DETAILED DESCRIPTION

One embodiment of the present invention provides a method comprising a data storage device having a device parameter, said data storage device identifying a firmware image that is associated with said device parameter and is a more current version than a firmware image installed on the data storage device, wherein the identified firmware image is available from a firmware repository. The method further comprises the data storage device initiating a download of the identified firmware image from the firmware repository during a period of time that the data storage device is handling no input-output tasks.

In preferred embodiments of the method, the data storage device may poll the firmware repository to determine whether the firmware repository contains a firmware image associated with a device parameter that matches a device parameter of the data storage device and is a more current version than a firmware image installed on the data storage device. Optionally, the data storage device may poll the firmware repository according to a predetermined schedule, in response to a predetermined condition, or during a period of time that the data storage device is handling no input-output activity. It should be recognized that the firmware repository is not a static collection of firmware images, but a dynamic firmware repository with new versions of firmware being posted to the firmware repository over time as new versions are written for any particular data storage device type or model, for example to provide a critical fix, performance enhancement, or new feature.

In one option, the firmware repository is stored on a host device selected from a server and a data storage subsystem. Such a host device may make its firmware repository available to a plurality of data storage devices. For example, a plurality of data storage devices may be connected to the host device via an interface selected from Serial AT Attachment (SATA), Serial Attached Small Computer System Interface (SAS), Peripheral Component Interconnect (PCI), and Peripheral Component Interconnect Express (PCIe). Alternatively, the plurality of data storage devices may have access to the host device over a network, such as a storage area network, local area network or wide area network. Without limitation, the data storage device may be selected from a hard disk drive and a solid state drive.

In a further option, the method may include the host device advertising (i.e., broadcasting) a memory location of the firmware repository to the data storage device and a plurality of other data storage devices. The memory location may be directed to the entire firmware repository so that the data storage device may direct its polling to the firmware repository at that memory location. Furthermore, the host device may advertise a command or command format that may be used to poll the firmware repository.

The firmware repository preferably includes metadata for each of a plurality of firmware images available for download. For example, the metadata may identify, for each of the plurality of firmware images, a firmware version and one or more device parameter for which the firmware image is applicable. The firmware version may be an alphanumeric code, such as “V5.14”. Any known or viable versioning scheme may be used, but the most typically with include a version number. Firmware version numbers are typically ascending with each version, such that the firmware image having the highest version number is the most current. In one specific implementation, the data storage device may determine whether a firmware image on the firmware repository is a more current version than the firmware image that is installed on the data storage device by comparing a version number associated with the firmware image on the firmware repository to a version number associated with the firmware image installed on the data storage device.

The one or more device parameter may be a device model or device type, such as a device model name, device model code, device type name or device type code. A data storage device may store its own device parameters in vital product data (VPD) and poll the firmware repository for firmware images associated with a matching device parameter or device parameters. Optionally, the metadata may further identify, for each of the plurality of firmware images, a size and location of the firmware image.

In a further option of the method, the data storage device may pause the download of the firmware image from the firmware repository in response to receiving an input-output task. Accordingly, the handling of input-output tasks is given priority over downloading the firmware image, even if that means that the download is paused any number of times before completing the download. Since the data storage device is able to easily identify its own idle periods, the data storage device is in a unique position to determine the best times to download a new firmware image. If the data storage device has initiated a download but detects an incoming input-output task, the download may be paused to handle the task and then subsequently resumed when the data storage device has no more pending input-output tasks.

In another embodiment, the data storage device may, for example, initiate a download of the identified firmware image from the firmware repository only if the period of time that the data storage device is handling no input-output tasks has exceeded a threshold period of time. Since an instantaneous period of time without an input-output task may not indicate a particularly beneficial opportunity to download a firmware image, embodiments of the method may require more than a threshold period of time without an input-output task before initiating a download.

A new firmware image may be installed at any time after being completely downloaded. However, according to one implementation, the data storage device may automatically install the firmware image in response to completing the download of the firmware image. According to another implementation, the data storage device may complete the download of the firmware image, and then install the downloaded firmware image in response to an installation instruction from a host device to which the data storage device is connected. The use of an installation instruction to trigger installation of a previously downloaded firmware image provides an administrator or administrative software greater control over when the data storage device will become available.

Furthermore, each of the individual policies or optional features that implement embodiments of the invention herein may be configured by the host device or a storage subsystem to which the drive is attached. For example, a user interface or an administrative application program may be used to determine the parameters of the individual policies and then transmit these parameters to the data storage device for use in controlling the operation of the data storage device. These policies may determine, without limitation, how often the data storage device interacts with the firmware repository to determine if a firmware update is available, how long a period of in-activity is required before the data storage device begins to download the firmware image, and whether the data storage device should attempt to activate the new firmware image at the conclusion of the transfer or await an activation instruction from the host device or storage subsystem.

Another embodiment of the present invention provides a computer program product comprising a non-transitory computer readable storage medium having program instructions embodied therewith, wherein the program instructions are executable by a processor to cause the processor to perform a method. The method comprises a data storage device identifying a firmware image that is associated with a device parameter that matches a device parameter of the data storage device and is a more current version than a firmware image installed on the data storage device, wherein the identified firmware image is available for download from a firmware repository. The method further comprises the data storage device initiating a download of the identified firmware image from the firmware repository during a period of time that the data storage device is handling no input-output tasks.

The foregoing computer program products may further include program instructions for implementing or initiating any one or more aspects of the methods described herein. Accordingly, a separate description of the methods will not be duplicated in the context of a computer program product.

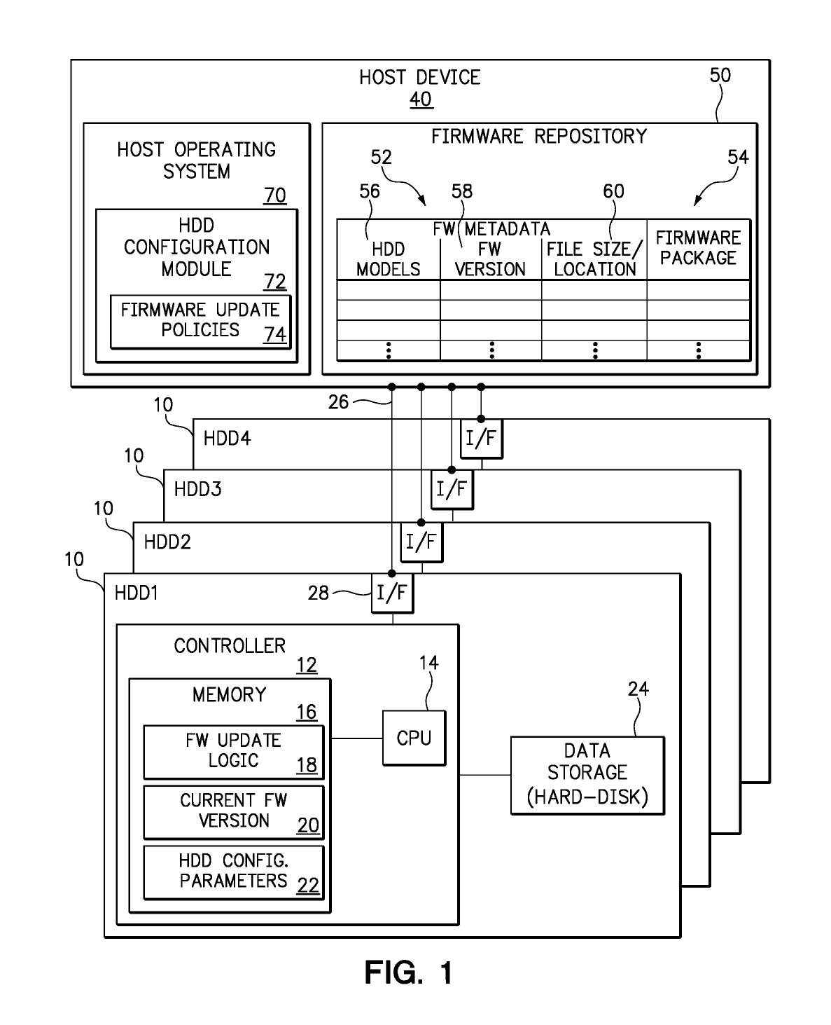

FIG. 1 is a diagram of a plurality of data storage devices 10 coupled to a host device 40. A representative data storage device 10 is shown as a hard disk drive (HDD 1). While the other data storage devices (HDD 2, HDD 3 and HDD 4) may be similar hard disk drives, any of the data storage devices 10 may be another type or model of data storage device.

The representative data storage device 10 includes a controller 12 that may be based on a central processing unit (CPU) 14 and memory 16. The memory 16 may include firmware update logic 18 that performs various steps according to embodiments of the present invention. Furthermore, the memory 16 may store the current firmware version 20 that is installed on the data storage device 10 and various configuration parameters 22 that may be used to affect how the firmware update logic 18 is implemented. For example, the configuration parameters 22 may include a time period for which the data storage device must have no input-output tasks before initiating a firmware download. An input-output task may include a read command to provide data from a data storage media (hard disk) 24 or a write command to store data to the data storage media 24. The input-output tasks may be received from the host device 40 over a connection 26 to an interface 28, such as a SATA, SAS or PCI connector. Alternatively, the input-output tasks may be received from the host device 40 over a network connection (not shown).

The host device 40 may be a server or a storage subsystem. The host device 40, as well as other devices (not shown) may provide input-output tasks (read and write commands, etc.) to one or more of the data storage devices 10. For example, the host device 40 may execute application programs that require the data storage services of the data storage devices 10. Furthermore, the host device 40 stores the firmware repository 50, which includes various firmware images available for downloading. The firmware repository 50 is illustrated as a table, but may have any of a variety of known data structures. For example, the firmware repository 50 may include firmware packages (images) and metadata 52 associated with each of the firmware packages. In this illustration, the metadata 52 includes the hard disk drive models 56 for which the associated firmware image is intended, the firmware version 58 for the associated firmware image, and the file size and location 60 of the firmware image. Data may be “associated” by virtue of being stored in the fields of a common record, which is illustrated as the blocks in a common row of the table. Accordingly, the metadata associated with a given firmware image may be stored in a common record with the firmware image.

The host device 40 may further have a host operating system 70 that include a hard disk drive configuration module 72. The configuration module 72 may provide the logic and user interface to form the firmware update policies 74. For example, the firmware update policies 74 may be communicated to each of the data storage devices 10, which then store the configuration parameters 22 to implement those policies.

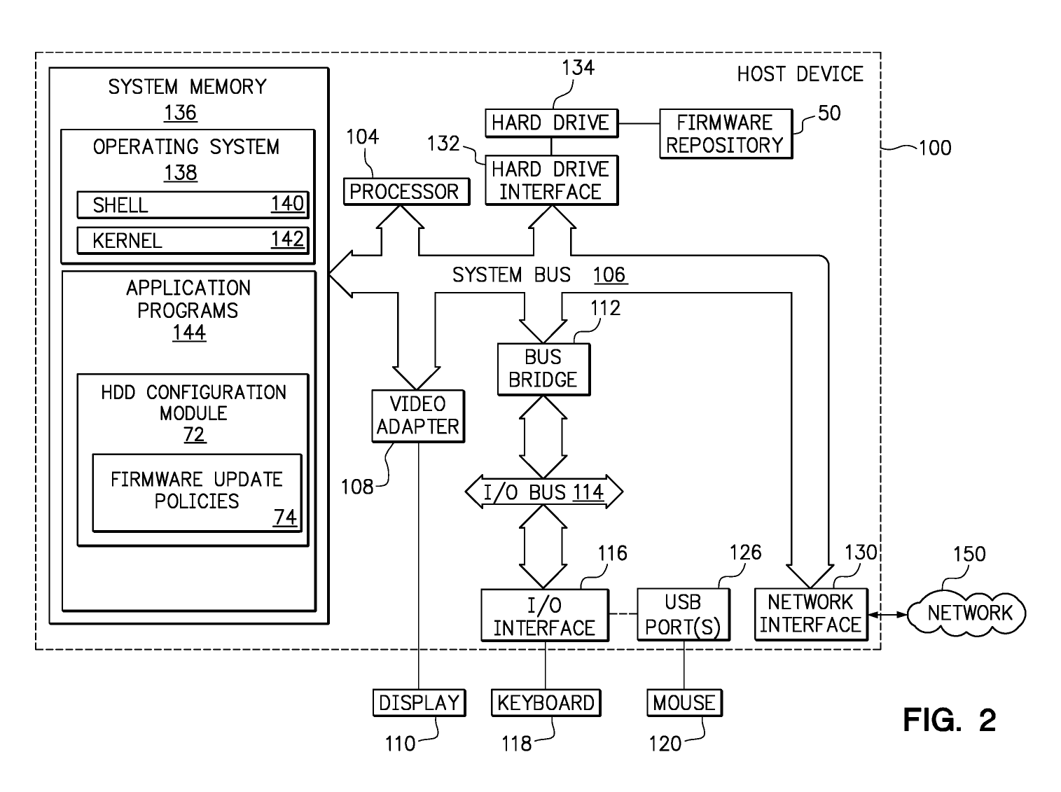

FIG. 2 is a diagram of a generic computer 100 that is representative of the host device 40 of FIG. 1, according to one embodiment of the present invention. The computer 100 includes a processor unit 104 that is coupled to a system bus 106. The processor unit 104 may utilize one or more processors, each of which has one or more processor cores. A video adapter 108, which drives/supports a display 110, is also coupled to system bus 106. The system bus 106 is coupled via a bus bridge 112 to an input/output (I/O) bus 114. An I/O interface 116 is coupled to the I/O bus 114. The I/O interface 116 affords communication with various I/O devices, including a keyboard 118, and a USB mouse 124 via USB port(s) 126. As depicted, the computer 100 is able to communicate with other network devices, or even various data storage devices 10 (see FIG. 1) over the network 150 using a network adapter or network interface controller 130.

A hard drive interface 132 is also coupled to the system bus 106 and may store the firmware repository 50. The hard drive interface 132 interfaces with a hard drive 134. In a preferred embodiment, the hard drive 134 communicates with system memory 136, which is also coupled to the system bus 106. System memory is defined as a lowest level of volatile memory in the computer 100. This volatile memory includes additional higher levels of volatile memory (not shown), including, but not limited to, cache memory, registers and buffers. Data that populates the system memory 136 includes the operating system (OS) 138 and application programs 144.

The operating system 138 includes a shell 140 for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while the shell 140 may be a text-based, line-oriented user interface, the present invention may support other user interface modes, such as graphical, voice, gestural, etc.

As depicted, the operating system 138 also includes the kernel 142, which includes lower levels of functionality for the operating system 138, including providing essential services required by other parts of the operating system 138 and application programs 144. Such essential services may include memory management, process and task management, disk management, and mouse and keyboard management. The operating system 138 further includes various configuration parameters 143, such as an Ethernet media access control (MAC) address, a fiber channel world-wide name (WWN), or a storage adapter parameter for providing connectivity to a storage area network (SAN).

As shown, the computer 100 includes application programs 144 in the system memory of the computer 100. The application programs 144 may include the hard disk drive configuration module 72, which may include the firmware update policies 74. For example, the firmware update policies 74 may be communicated to each of the data storage devices 10, which then store the configuration parameters 22 to implement those policies.

The hardware elements depicted in the computer 100 are not intended to be exhaustive, but rather are representative. For instance, the computer 100 may include alternate memory storage devices such as magnetic cassettes, digital versatile disks (DVDs), Bernoulli cartridges, and the like. These and other variations are intended to be within the scope of the present invention.

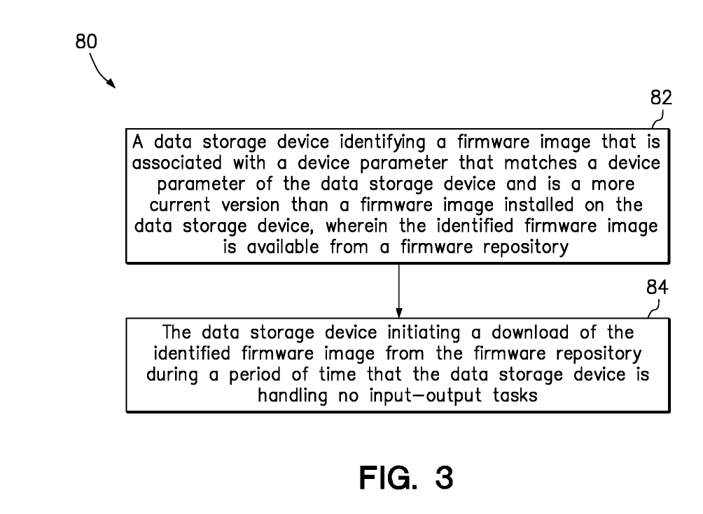

FIG. 3 is a flowchart of a method 80 according to one embodiment of the present invention. In step 82, the method includes a data storage device identifying a firmware image that is associated with a device parameter that matches a device parameter of the data storage device and is a more current version than a firmware image installed on the data storage device, wherein the identified firmware image is available from a firmware repository. In step 84, the method includes the data storage device initiating a download of the identified firmware image from the firmware repository during a period of time that the data storage device is handling no input-output tasks.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage medium (including forms referred to as volatile memory) is, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored as non-transitory program instructions in a computer readable storage medium that can direct a computer, other programmable data processing apparatus, or other devices to function in a particular manner, such that the program instructions stored in the computer readable storage medium produce an article of manufacture including non-transitory program instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
a data storage device having a device parameter, said data storage device identifying a firmware image that is associated with said device parameter and is a more current version than a firmware image installed on the data storage device, wherein the identified firmware image is available from a firmware repository; and
the data storage device initiating a download of the identified firmware image from the firmware repository during a period of time that the data storage device is handling no input-output tasks.

2. The method of claim 1, wherein the data storage device is selected from a hard disk drive and a solid state drive.

3. The method of claim 1, further comprising:
the data storage device polling the firmware repository to determine whether the firmware repository contains a firmware image associated with a device parameter that matches a device parameter of the data storage device and is a more current version than a firmware image installed on the data storage device.

4. The method of claim 1, wherein the data storage device polls the firmware repository according to a predetermined schedule.

5. The method of claim 1, wherein the data storage device polls the firmware repository during a period of time that the data storage device is handling no input-output activity.

6. The method of claim 1, wherein the firmware repository is stored on a host device selected from a server and a data storage subsystem.

7. The method of claim 6, wherein the data storage device is connected to the host device via an interface selected from SATA, SAS, and PCI.

8. The method of claim 6, further comprising:
the host device advertising a memory location of the firmware repository to the data storage device and a plurality of other data storage devices.

9. The method of claim 1, wherein the firmware repository includes metadata for each of a plurality of firmware images available for download, wherein the metadata identifies, for each of the plurality of firmware images, a firmware version and one or more data storage device models for which the firmware image is applicable.

10. The method of claim 9, wherein the metadata further identifies, for each of the plurality of firmware images, a size and location of the firmware image.

11. The method of claim 9, wherein the data storage device determines whether a firmware image on the firmware repository is a more current version than the firmware image that is installed on the data storage device by comparing a version number associated with the firmware image on the firmware repository to a version number associated with the firmware image installed on the data storage device.

12. The method of claim 1, further comprising:
the data storage device pausing the download of the firmware image from the firmware repository in response to receiving an input-output task.

13. The method of claim 1, wherein the data storage device initiates a download of the identified firmware image from the firmware repository only if the period of time that the data storage device is handling no input-output tasks has exceeded a threshold period of time.

14. The method of claim 1, further comprising:
the data storage device automatically installing the firmware image in response to completing the download of the firmware image.

15. The method of claim 1, further comprising:
the data storage device completing the download of the firmware image; and then
the data storage device installing the downloaded firmware image in response to an installation instruction from a host device to which the data storage device is connected.

16. A computer program product comprising a non-transitory computer readable storage medium having program instructions embodied therewith, the program instructions executable by a processor to cause the processor to perform a method comprising:
a data storage device identifying a firmware image that is associated with a device parameter that matches a device parameter of the data storage device and is a more current version than a firmware image installed on the data storage device, wherein the identified firmware image is available from a firmware repository; and
the data storage device initiating a download of the identified firmware image from the firmware repository during a period of time that the data storage device is handling no input-output tasks.

17. The computer program product of claim 16, the method further comprising:
the data storage device polling the firmware repository to determine whether the firmware repository contains a firmware image associated with a device parameter that matches a device parameter of the data storage device and is a more current version than a firmware image installed on the data storage device.

18. The computer program product of claim 16, wherein the firmware repository is stored on a host device selected from a server and a data storage subsystem, the method further comprising:
the host device advertising a memory location of the firmware repository to the data storage device and a plurality of other data storage devices.

19. The computer program product of claim 16, the method further comprising:
the data storage device pausing the download of the firmware image from the firmware repository in response to receiving an input-output task.

20. The computer program product of claim 16, wherein the data storage device determining whether the data storage device is currently handling an input-output task, includes the data storage device determining whether the data storage device has handled any input-output tasks during a trailing threshold period of time.
